(19) United States
(12) Patent Application Publication
(10) Pub. No.: US 2015/0309923 A1
(43) Pub. Date: Oct. 29, 2015

(54) STORAGE CONTROL APPARATUS AND STORAGE SYSTEM

(71) Applicant: FUJITSU LIMITED, Kawasaki-shi (JP)

(72) Inventors: Satoshi Iwata, Yokohama (JP); Motoyuki Kawaba, Kawasaki (JP)

(73) Assignee: FUJITSU LIMITED, Kawasaki-shi (JP)

(21) Appl. No.: 14/629,847

(22) Filed: Feb. 24, 2015

(30) Foreign Application Priority Data
Apr. 28, 2014 (JP) 2014-092781

(51) Int. Cl. G06F 12/02; G06F 3/06

(52) U.S. Cl. CPC G06F 12/0215; G06F 3/0611; G06F 3/0653; G06F 3/0685; G06F 2212/1024

(57) ABSTRACT

A storage control apparatus includes a processor. The processor is configured to detect a dependency relationship between a first data access and a second data access made after passage of a delay time from the first data access. The first data access is made to a first storage area in a first storage device. The second data access is made to a second storage area in the first storage device. The processor is configured to transfer, when a current data access is made to the first storage area in a state in which the dependency relationship is detected, data in the second storage area to a second storage device before the delay time passes. The second storage device has a higher access speed than the first storage device.

### CROSS-REFERENCE TO RELATED APPLICATION

This application is based upon and claims the benefit of priority of the prior Japanese Patent Application No. 2014-092781, filed on Apr. 28, 2014, the entire contents of which are incorporated herein by reference.

### FIELD

The embodiments discussed herein are related to a storage control apparatus and a storage system.

### BACKGROUND

As one of high speed techniques in the storage field, “read ahead” is provided. In general, a storage apparatus (storage device) is provided with a large-capacity and inexpensive hard disk drive (HDD), and stores data in the HDD. The storage apparatus is also provided with a solid state drive (SSD), or a dynamic random access memory (DRAM), which is more expensive per unit capacity compared with the HDD, but is capable of accessing at a higher speed. The storage apparatus reads ahead, from the HDD, data having a high possibility of being accessed, and copies the data to the SSD or the DRAM in advance so as to achieve high-speed access on the whole.

It is known that such read ahead is performed, for example, to read a continuous area when sequential access is detected, or performed based on access frequencies when random access is made.

Related techniques are disclosed, for example, in Japanese Laid-open Patent Publication No. 2008-165315, Japanese Laid-open Patent Publication No. 2011-138321, Japanese Laid-open Patent Publication No. 2004-133934, Japanese Laid-open Patent Publication No. 2000-250803, and Japanese Laid-open Patent Publication No. 2009-266152.

However, there is still a room for improvement in high-speed access to a storage device by reading ahead, and it is hard to say that the access performance is sufficient.

### SUMMARY

According to an aspect of the present invention, provided is a storage control apparatus including a processor. The processor is configured to detect a dependency relationship between a first data access and a second data access made after passage of a delay time from the first data access. The first data access is made to a first storage area in a first storage device. The second data access is made to a second storage area in the first storage device. The processor is configured to transfer, when a current data access is made to the first storage area in a state in which the dependency relationship is detected, data in the second storage area to a second storage device before the delay time passes. The second storage device has a higher access speed than the first storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage system according to a first embodiment;

FIG. 2 is a diagram illustrating an exemplary configuration of a storage system according to a second embodiment;

FIG. 3 is a diagram illustrating an exemplary configuration of a storage device to be targeted for control by the storage apparatus according to the second embodiment;

FIG. 4 is a diagram illustrating an exemplary hardware configuration of a CM according to the second embodiment;

FIG. 5 is a diagram illustrating a flowchart of number-of-accesses count processing according to the second embodiment;

FIG. 6 is a diagram illustrating an example of an access counter table according to the second embodiment;

FIG. 7 is a diagram illustrating a flowchart of read-ahead control processing according to the second embodiment;

FIG. 8 is a diagram illustrating an example of a high-load segment table according to the second embodiment;

FIG. 9 is a diagram illustrating a flowchart of dependency relationship detection processing according to the second embodiment;

FIG. 10 is a diagram illustrating an example of a high-load segment log table according to the second embodiment;

FIG. 11 is a diagram illustrating an example of a frequency table according to the second embodiment;

FIG. 12 is a diagram illustrating an example of a dependency relationship table according to the second embodiment;

FIG. 13 is a diagram illustrating a flowchart of frequency table update processing according to the second embodiment;

FIG. 14 is a diagram illustrating a frequency table of combinations (from segment ID “S#0” to “S#322”) of a current high-load segment and a past high-load segment according to the second embodiment;

FIG. 15 is a diagram illustrating a frequency table of combinations (from segment ID “S#5” to “S#322”) of a current high-load segment and a past high-load segment according to the second embodiment;

FIG. 16 is a diagram illustrating a frequency table of combinations (from segment ID “S#225” to “S#322”) of a current high-load segment and a past high-load segment according to the second embodiment;

FIG. 17 is a diagram illustrating a flowchart of high-frequency category search processing according to the second embodiment;

FIG. 18 is a diagram illustrating an example of a histogram based on the frequency table according to the second embodiment;

FIG. 19 is a diagram illustrating an example of a histogram based on the frequency table according to the second embodiment;

FIG. 20 is a diagram illustrating a flowchart of dependency relationship table update processing according to the second embodiment;

FIG. 21 is a diagram illustrating a flowchart of read-ahead data determination processing according to the second embodiment;

FIG. 22 is a diagram illustrating an example of a transfer scheduled segment table according to the second embodiment; and

FIG. 23 is a diagram illustrating a flowchart of data transfer processing according to the second embodiment.

### DESCRIPTION OF EMBODIMENTS

In the following, a detailed description will be given of embodiments with reference to the drawings.

### First Embodiment

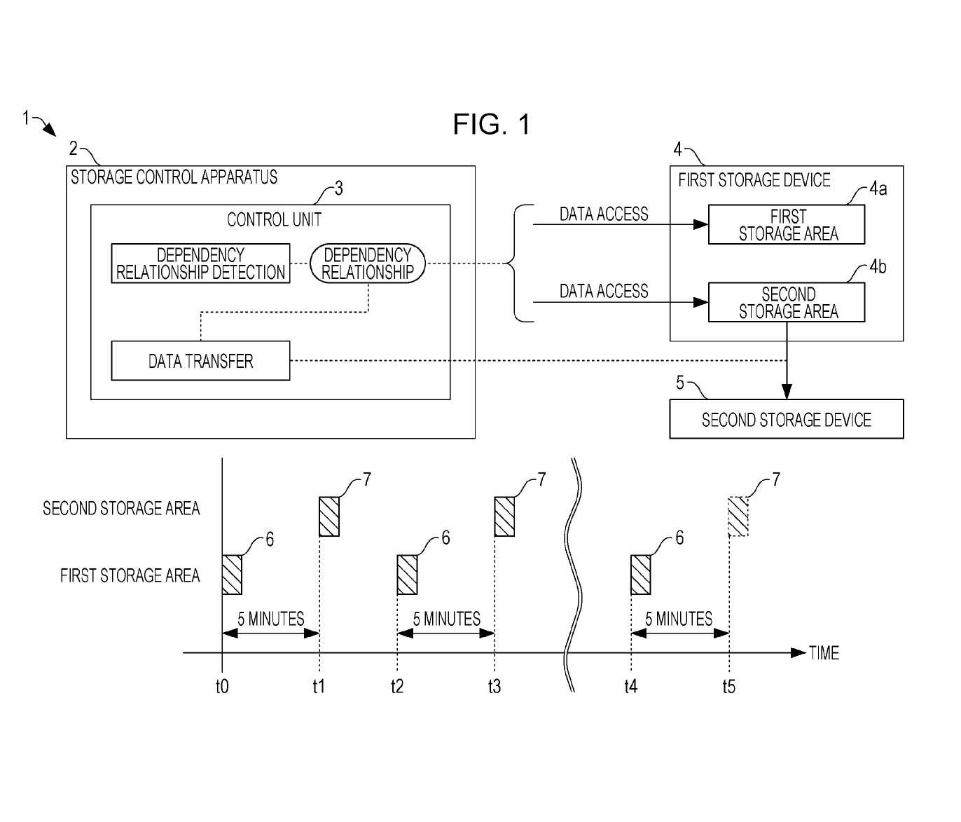

First, a description will be given of a storage system according to a first embodiment with reference to FIG. 1. FIG. 1 is a diagram illustrating an exemplary configuration of a storage system according to the first embodiment.

A storage system 1 includes a storage control apparatus 2, a first storage device 4, and a second storage device 5. The storage control apparatus 2 performs control on the first storage device 4 and the second storage device 5. The first storage device 4 and the second storage device 5 are storage devices capable of storing data in a predetermined storage area, and include an HDD, an SSD, a DRAM, or the like, for example. The second storage device 5 is a storage device capable of making an access at a higher speed than the first storage device 4. When the first storage device 4 is an HDD, the second storage device 5 is an SSD, for example. When the first storage device 4 is an HDD or an SSD, the second storage device 5 is a DRAM, for example.

The storage control apparatus 2 performs “read ahead”, which copies data stored in the first storage device 4 to the second storage device 5 in advance so as to speed up data access. The “read ahead” means reading data stored in a low-speed device into a high-speed device in advance before an access is made to the data in the low-speed device. Access (data access) to data, mentioned here, includes writing data in addition to reading data.

The storage control apparatus 2 includes a control unit 3. The control unit 3 detects a dependency relationship in which, after passage of a predetermined time from a time point of data access to a first storage area 4a in the first storage device 4, data access is made to a second storage area 4b in the first storage device 4.

For example, it is assumed that data access is made to data 6 in the first storage area 4a at timing t0, and then data access is made to data 7 in the second storage area 4b at timing t1 which is five minutes after t0. Also, it is assumed that data access is made to data 6 in the first storage area 4a at timing t2, and then data access is made to data 7 in the second storage area 4b at timing t3 which is five minutes after t2. By observing such a data access pattern, the control unit 3 may detect, based on a predetermined detection criteria, a dependency relationship in which it is highly probable that after passage of a predetermined time (for example, after the elapse of five minutes) of data access to the data 6 in the first storage area 4a, data access is made to the data 7 in the second storage area 4b. To put it another way, it is possible to say that a dependency relationship has a deviation in the timing of accessing data.

When data access is made to the first storage area 4a in a state of having detected the dependency relationship, the control unit 3 copies data in the second storage area 4b from the first storage device 4 to the second storage device 5 before the predetermined time passes.

For example, the control unit 3 detects that data access is made to data 6 in the first storage area 4a at timing t4. At this time, it is assumed that the control unit 3 has detected a dependency relationship in which after the elapse of five minutes from the data access to the data 6 in the first storage area 4a, data access is made to the data 7 in the second storage area 4b. The control unit 3 copies the data 7 from the first storage device 4 to the second storage device 5 before timing t5 which is five minutes after the timing t4.

The control unit 3 performs read ahead in this manner so as to improve access performance in the first storage device 4 and the second storage device 5.

### Second Embodiment

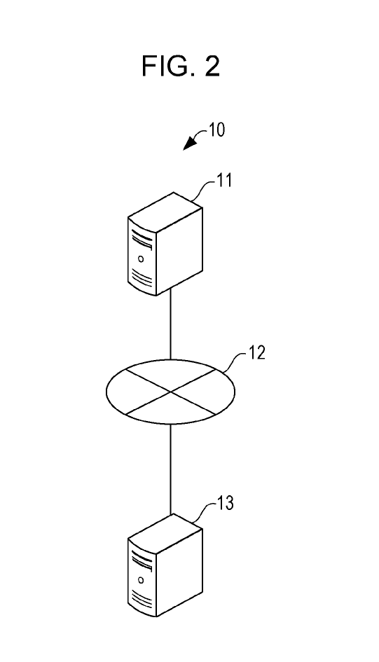

Next, a description will be given of a storage system according to a second embodiment with reference to FIG. 2. FIG. 2 is a diagram illustrating an exemplary configuration of a storage system according to the second embodiment.

A storage system 10 includes a host 11, and a storage apparatus 13 which connects to the host 11 through a network 12. The storage system 10 writes data to the storage apparatus 13, or reads data from the storage apparatus 13 in accordance with an input/output (I/O) request demanded by the host 11.

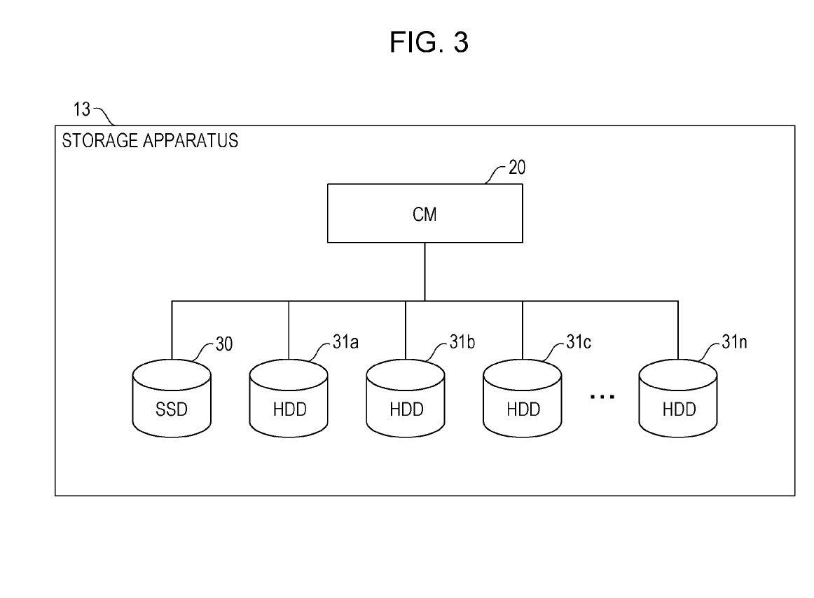

Next, a description will be given of a configuration of a storage device that is a target of control by the storage apparatus 13 according to the second embodiment with reference to FIG. 3. FIG. 3 is a diagram illustrating an exemplary configuration of a storage device to be targeted for control by the storage apparatus 13 according to the second embodiment.

The storage apparatus 13 includes a controller module (CM) 20, an SSD 30, and HDDs 31 (31a, 31b, 31c, . . . , and 31n). The storage apparatus 13 includes one SSD 30, but may include two or more SSDs 30. The storage apparatus 13 includes a plurality of HDDs 31a, 31b, 31c, . . . , and 31n. The storage apparatus 13 is not limited to the case of including the SSD 30 and the HDDs 31 inside the apparatus, but may be externally connected to the SSD 30 and the HDDs 31.

The CM 20 functions as a control unit that controls the SSD 30 and the HDDs 31. The SSD 30 functions as a storage device capable of accessing at a higher speed compared with the HDDs 31. That is to say, the HDDs 31 correspond to the first storage device 4 in the first embodiment, and the SSD 30 corresponds to the second storage device 5 in the first embodiment. The HDDs 31 function as a large-capacity storage device compared with the SSD 30. Accordingly, the SSD 30 is a storage device capable of functioning as a cache memory with respect to the HDDs 31.

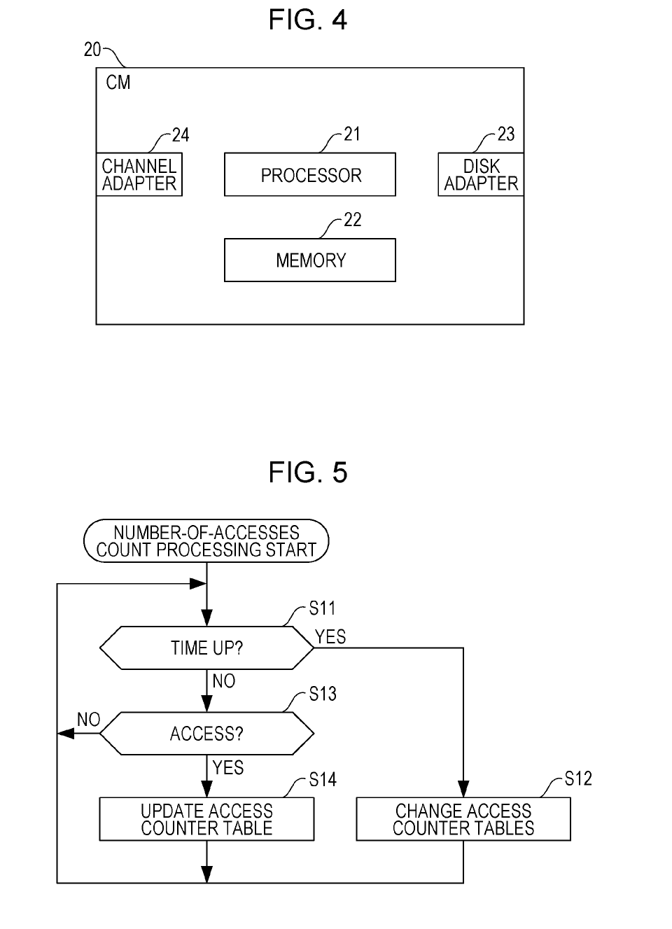

Next, a description will be given of a hardware configuration of the CM 20 according to the second embodiment with reference to FIG. 4. FIG. 4 is a diagram illustrating an exemplary hardware configuration of the CM 20 according to the second embodiment.

The CM 20 is one mode of the storage control apparatus, and receives an I/O request (a write request, a read request, or the like) from the host 11, and controls access to the SSD and the HDDs. The storage apparatus 13 illustrated in FIG. 3 includes one CM 20, but may have a redundant configuration including two or more CMs 20.

The CM 20 includes a processor 21, a memory 22, a disk adapter 23, and a channel adapter 24. The processor 21, the memory 22, the disk adapter 23, and the channel adapter 24 are connected one another through a bus (not illustrated). The CM 20 is connected to the SSD 30 or the HDDs 31 through the disk adapter 23, and is connected to the host 11 through the channel adapter 24.

The processor 21 controls the overall CM 20, and performs control of the SSD 30 and the HDDs 31. The processor 21 may be a multi-processor. The processor 21 is, for example, a central processing unit (CPU), a micro processing unit (MPU), a digital signal processor (DSP), an application specific integrated circuit (ASIC), or a programmable logic device (PLD). Also, the processor 21 may be a combination of two or more elements among a CPU, an MPU, a DSP, an ASIC, and a PLD.

The memory 22 includes a random access memory (RAM), and a nonvolatile memory, for example. The memory 22 holds data when the data is read from the SSD 30 or the HDD 31. The memory 22 also stores user data and control information. For example, the RAM is used as a main storage device of the CM 20. The RAM temporarily stores at least part of an operating system (OS) program, firmware, and an application program, which are executed by the processor 21. The RAM also stores various kinds of data used for processing by the processor 21. The RAM may include a cache memory separately from the memory used for storing various kinds of data.

The nonvolatile memory holds memory contents even at the time of power shut off to the storage apparatus 13. The nonvolatile memory is, for example, a semiconductor storage device, such as an electrically erasable and programmable read-only memory (EEPROM), a flash memory, or the like, or an HDD or the like. The nonvolatile memory stores the OS program, the firmware, the application program, and various kinds of data.

The disk adapter 23 performs interface control with the SSD 30 and the HDD 31. The channel adapter 24 performs interface control with the host 11.

With the above hardware configuration, the processing function of the CM 20 (storage apparatus 13) according to the second embodiment may be achieved. It is also possible to achieve the storage control apparatus 2 illustrated in the first embodiment by similar hardware to that of the CM 20 illustrated in FIG. 4.

The CM 20 executes, for example, a program recorded in a computer-readable recording medium so as to achieve the processing function of the second embodiment. The program in which the processing contents to be executed by the CM 20 are described may be stored in various recording media. For example, the program to be executed by the CM 20 may be stored in a nonvolatile memory. The processor 21 loads at least a part of the program in the nonvolatile memory to the memory 22, and executes the program. The program to be executed by the CM 20 may also be stored in a portable recording medium, such as an optical disc, a memory device, a memory card, or the like (not illustrated). The optical disc includes a digital versatile disc (DVD), a DVD-RAM, a compact disc read-only memory (CD-ROM), a CD recordable/rewritable (CD-R/RW), and the like. The memory device is a recording medium provided with a communication function with an input/output interface or a device connection interface (not illustrated). For example, the memory device may write data to a memory card or read data from the memory card by the memory reader/writer. The memory card is a card-type recording medium.

The program stored in the portable recording medium is installed into the nonvolatile memory under control of the processor 21, for example, and then becomes possible to be executed. The processor 21 may directly read the program from the portable recording medium to execute the program.

Next, a description will be given of number-of-accesses count processing according to the second embodiment with reference to FIG. 5. FIG. 5 is a flowchart illustrating the number-of-accesses count processing according to the second embodiment.

The number-of-accesses count processing is processing for recording the number of accesses per minute for each segment. The number-of-accesses count processing is processing executed by the control unit (CM 20) after starting the storage apparatus 13.

A segment is a management unit produced by dividing the storage area to be managed into parts having a predetermined unit size. For example, when the control unit (CM 20) manages a storage area of 100 GB, a storage area of one GB, which is a unit produced by division of 100 GB by 100, becomes one segment. A unit of one-100th thereof is an example in order to restrict the dependency relationships up to about 10,000 (=100×100) varieties, and thus the division is not limited to this.

S11: The control unit determines whether the timer of recording unit time (one minute) has expired or not. The recording unit time of the number of accesses is not limited to one minute, and may be determined in view of performing a suitable sampling, for example, assuring sufficient data, or the like. If the control unit determines that the timer has expired, the processing proceeds to S12, whereas if the control unit does not determine that the timer has expired, the processing proceeds to S13.

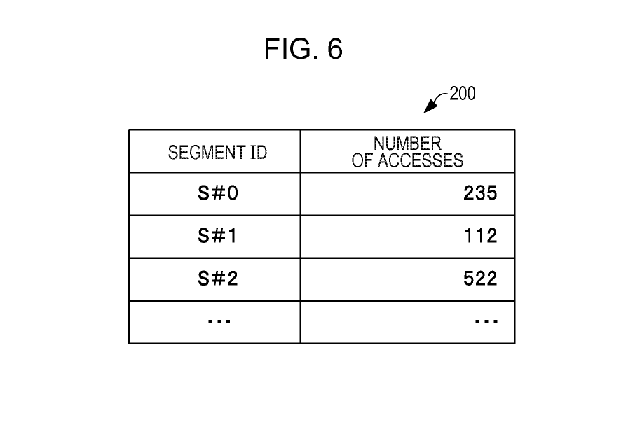

S12: The control unit changes the access counter tables. The control unit provides an access counter table for each recording unit time, and changes the access counter table for each one recording unit time. A description will be given later of the details of the access counter table with reference to FIG. 6.

S13: The control unit determines whether there is access (for example, read access) to a segment or not. If the control unit determines that there is access to a segment, the processing proceeds to S14, whereas if the control unit determines that there is not access to a segment, the processing proceeds to S11.

S14: The control unit updates the access counter table corresponding to the current recording unit time. The control unit increments the number of accesses for the segment having the access by one so as to update the access counter table. After the control unit updates the access counter table, the processing proceeds to S11.

Thereby, the control unit may record, in the access counter table, the number of accesses to the segment for each recording unit time. The counting of the number of accesses for each segment in this manner makes it possible to reduce processing load on the control unit compared with the counting of the number of accesses for each file.

Next, a description will be given of the access counter table with reference to FIG. 6. FIG. 6 is a diagram illustrating an example of the access counter table according to the second embodiment. An access counter table 200 records the number of accesses to a segment for each recording unit time. The access counter table 200 includes an item “segment ID”, and an item “number of accesses”. The item “segment ID” records identification information capable of uniquely identifying a segment. The item “number of accesses” records the number of accesses to a segment identified by the segment ID. For example, the segment having the segment ID “S#0” has the number of accesses of “235”. The segment having the segment ID “S#1” has the number of accesses of “112”. The segment having the segment ID “S#2” has the number of accesses of “522”.

In this manner, the access counter table records the number of accesses to a segment for each recording unit time.

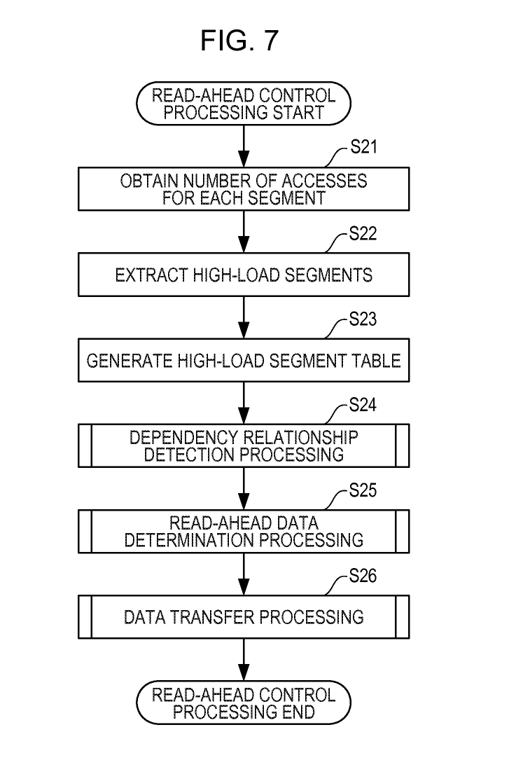

Next, a description will be given of read-ahead control processing according to the second embodiment with reference to FIG. 7. FIG. 7 is a flowchart illustrating the read-ahead control processing according to the second embodiment.

The read-ahead control processing is the processing for copying data of one segment from the HDD 31 to the SSD 30. The read-ahead control processing is performed by the control unit at each predetermined data transfer timing. The data transfer timing is a timing at which data transfer of one segment is performed from the HDD 31 to the SSD 30 to copy the data of the segment. The data transfer timing is determined in terms of a communication band that is allowed to be assigned to data transfer so that stable read ahead may be achieved. For example, in the case where it is possible to transfer data of one segment in one minute, the data transfer timing is for each one minute.

S21: The control unit obtains the number of accesses to each segment. The control unit refers to the access counter table of immediately before so that the number of accesses to each segment may be obtained.

S22: The control unit extracts high-load segments by comparing the number of accesses to each segment. A high-load segment is a segment determined to have a larger number of accesses on the basis of a predetermined determination criterion. For example, a high-load segment is a segment having the top number of accesses (for example, top three). The predetermined determination criterion may be determined to be all the segments exceeding a predetermined threshold value, or may be determined to be upper ones that exceed the predetermined threshold value.

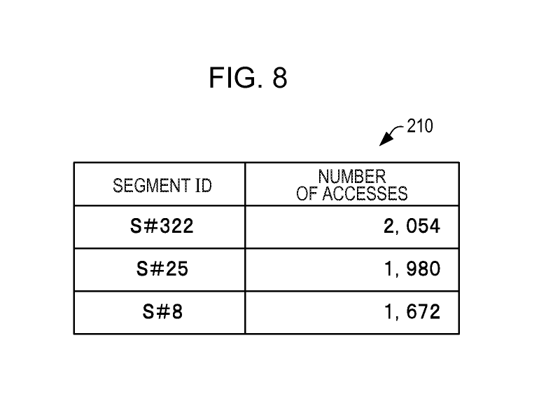

S23: The control unit generates a high-load segment table that records high-load segments. A description will be given later of the details of the high-load segment table with reference to FIG. 8.

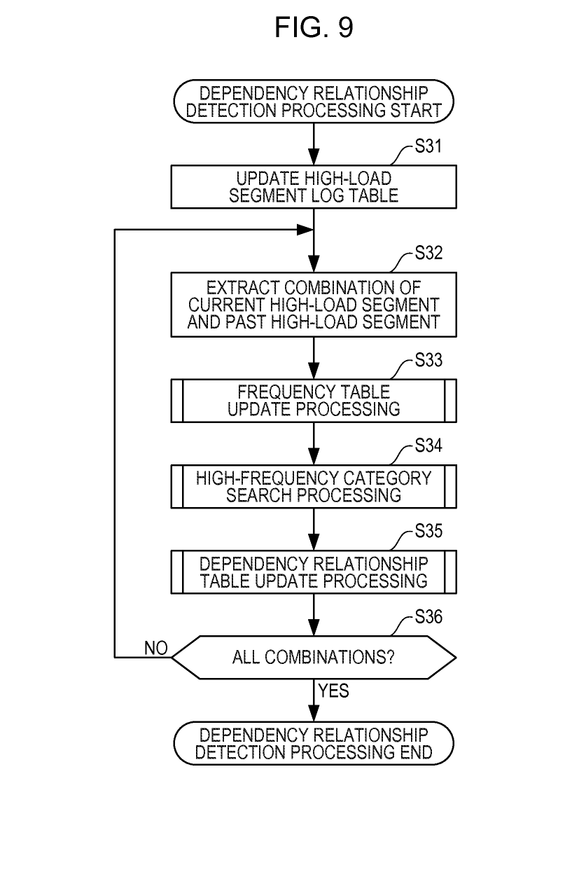

S24: The control unit performs dependency relationship detection processing. The dependency relationship detection processing is the processing for detecting, as a dependency relationship, two high-load segments having an access time difference. A description will be given later of the details of the dependency relationship detection processing with reference to FIG. 9.

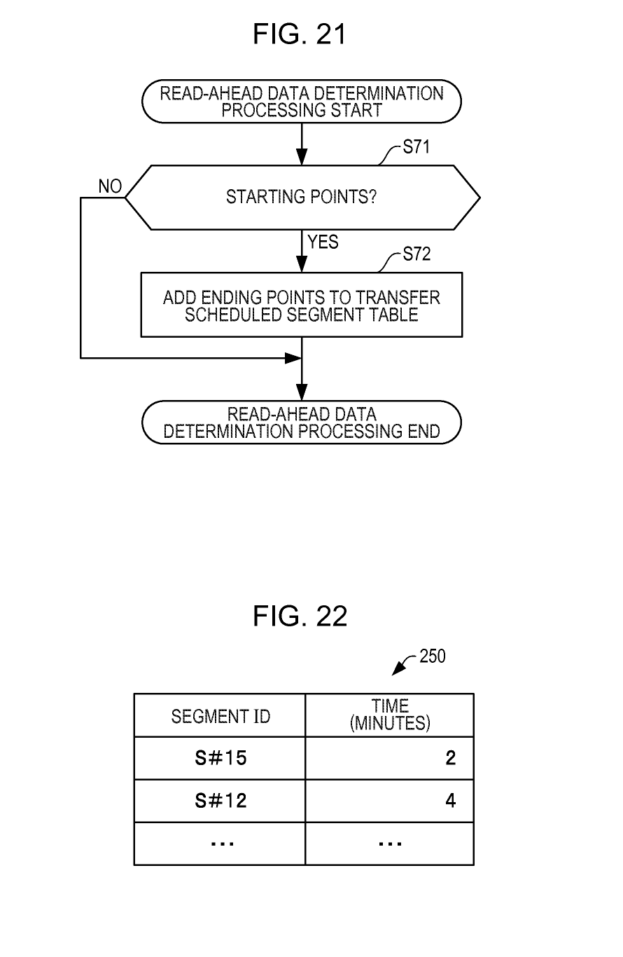

S25: The control unit performs read-ahead data determination processing. The read-ahead data determination processing is processing for determining data to be a target of read ahead. To put it another way, the read-ahead data determination processing is the processing for determining the segment that stores data to be a target of read ahead. A description will be given later of the details of the read-ahead data determination processing with reference to FIG. 21.

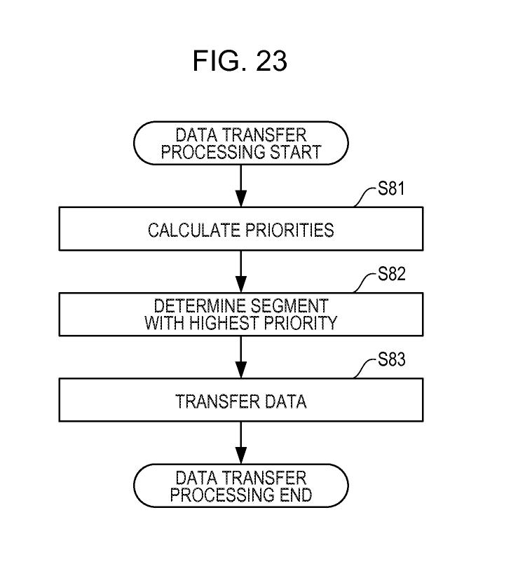

S26: The control unit performs data transfer processing. The data transfer processing is the processing for transferring (copying) the data stored in the segment determined in S25 to the SSD 30. A description will be given later of the details of the data transfer processing with reference to FIG. 23. After performing the data transfer processing, the control unit terminates the read-ahead control processing.

Next, a description will be given of the high-load segment table with reference to FIG. 8. FIG. 8 is a diagram illustrating an example of the high-load segment table according to the second embodiment. The high-load segment table 210 records the number of accesses to high-load segments for each recording unit time. The high-load segment table 210 includes an item “segment ID”, and an item “number of accesses”. The item “segment ID” records identification information that allows to uniquely identify a segment. The item “number of accesses” records the number of accesses to the segment identified by the segment ID. For example, the segment having the segment ID “S#322” has the number of accesses of “2,054”. The segment having the segment ID “S#25” has the number of accesses of “1,980”. The segment having the segment ID “S#8” has the number of accesses of “1,672”.

In this manner, the high-load segment table records the number of accesses to the high-load segments for each recording unit time.

Next, a description will be given of the dependency relationship detection processing according to the second embodiment with reference to FIG. 9. FIG. 9 is a flowchart illustrating the dependency relationship detection processing according to the second embodiment.

The dependency relationship detection processing is processing for detecting, as a dependency relationship, two high-load segments having an access time difference. The dependency relationship detection processing is the processing performed by the control unit in S24 of the read-ahead control processing.

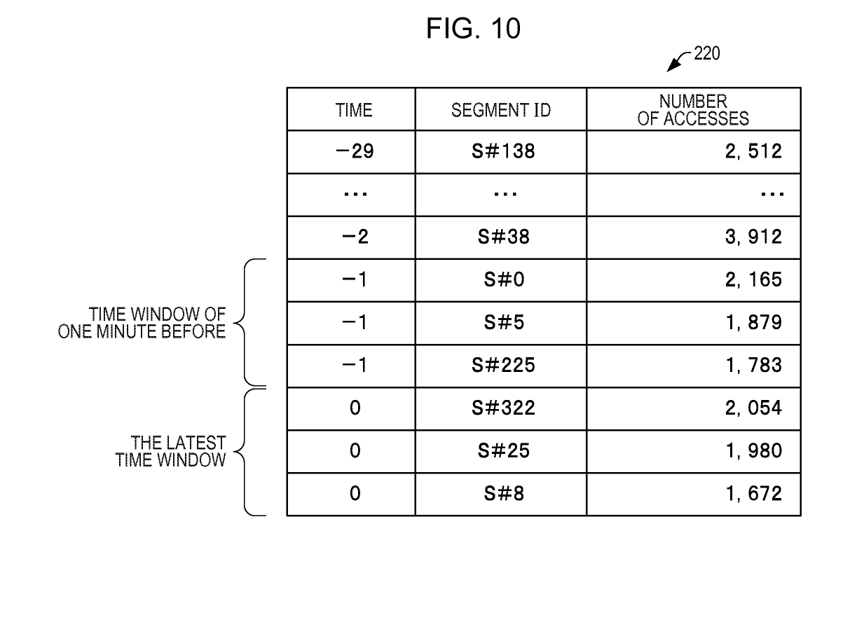

S31: The control unit updates a high-load segment log table. The high-load segment log table is a table that records high-load segments for a predetermined time period as a log. A description will be given later of the details of the high-load segment log table with reference to FIG. 10.

S32: The control unit extracts a combination of a current (the latest) high-load segment and a past high-load segment. This combination has an order relationship.

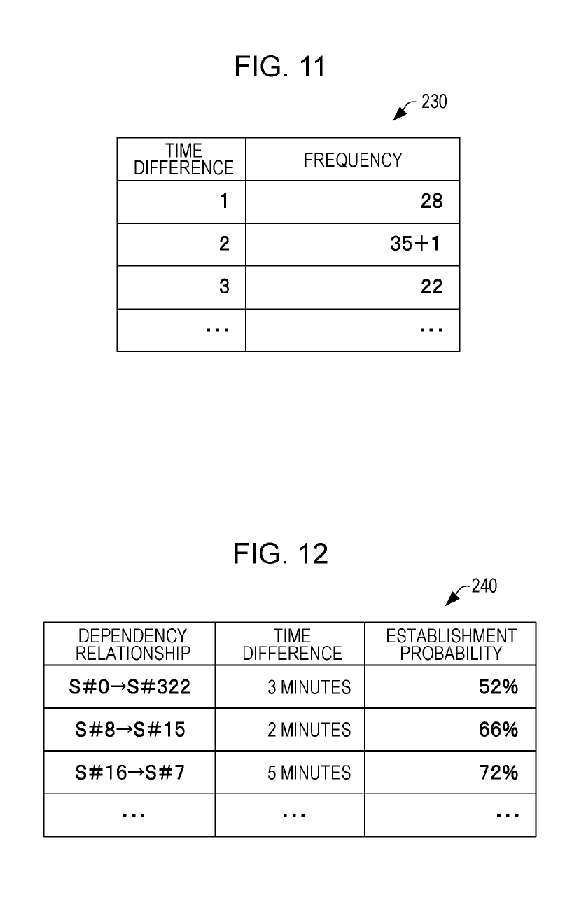

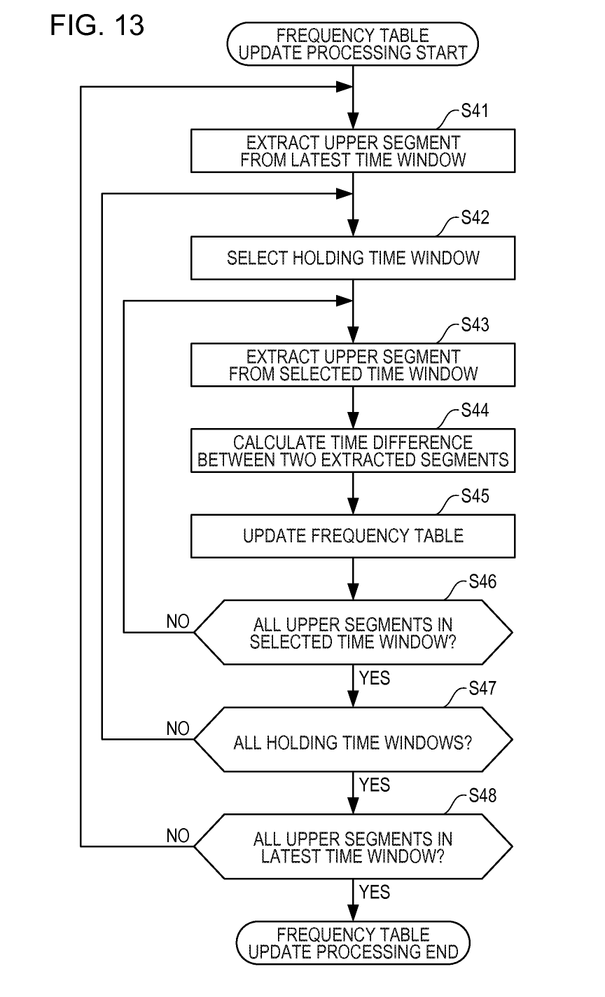

S33: The control unit performs frequency table update processing. The frequency table update processing is processing for updating a frequency table by reflecting the combination of high-load segments extracted in S32. A description will be given later of the details of the frequency table update processing with reference to FIG. 13. The frequency table is a table in which an access frequency per time difference for each combination of high-load segments is recorded. A description will be given later of the details of the frequency table with reference to FIG. 11.

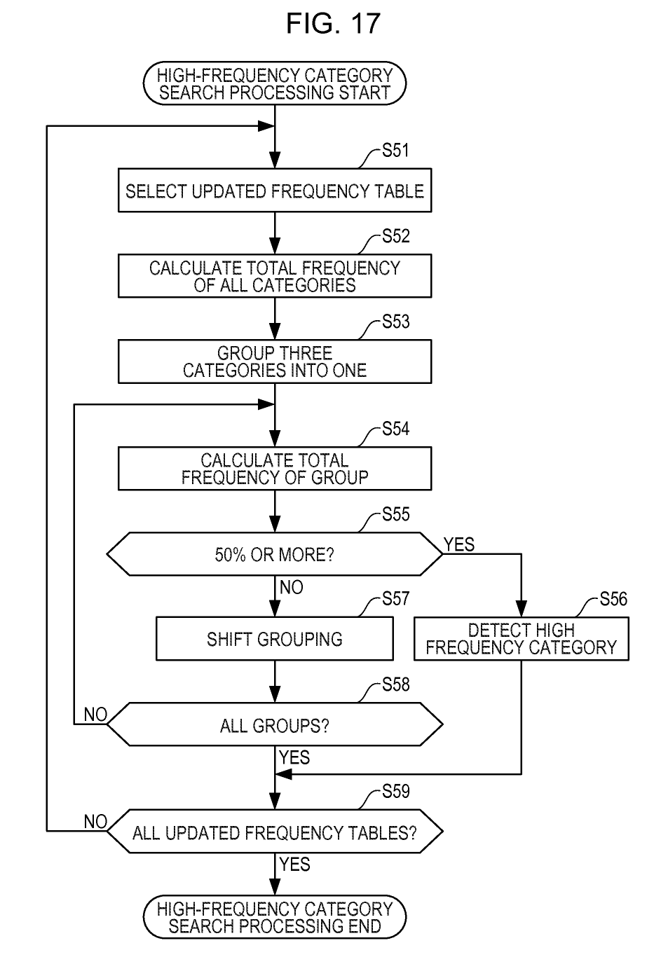

S34: The control unit performs high-frequency category search processing. The high-frequency category search processing is processing for searching, with reference to the frequency table, a combination of high-load segments having a heavy access frequency per time difference. It may be recognized that such a combination of high-load segments indicates that there is a dependency relationship in which, after the elapse of a predetermined time from access to one of the high-load segments, access is made to the other of the high-load segments. The high-frequency category search processing is the processing for detecting such a dependency relationship. A description will be given later of the details of the high-frequency category search processing with reference to FIG. 17.

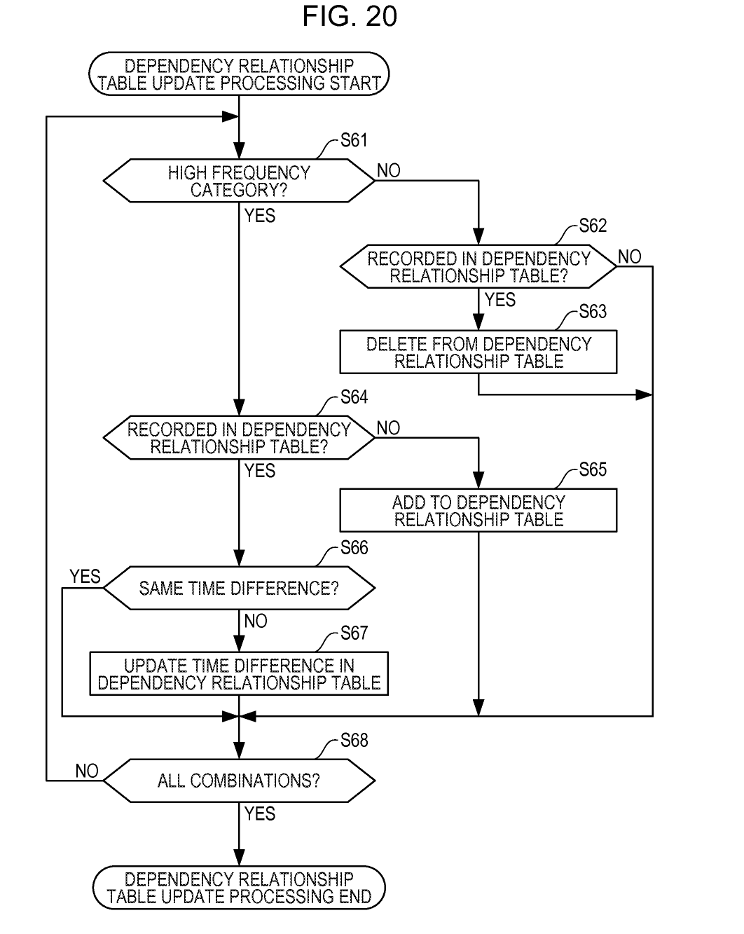

S35: The control unit performs dependency relationship table update processing. The dependency relationship table update processing is the processing for updating a dependency relationship table by reflecting the dependency relationship detected in S34. A description will be given later of the details of the dependency relationship table update processing with reference to FIG. 20. The dependency relationship table is a table that records the detected dependency relationship. A description will be given later of the details of the dependency relationship table with reference to FIG. 12.

S36: The control unit determines whether all the combinations of the current high-load segment and the past high-load segment have been extracted or not. If some of the combinations of high-load segments have not been extracted, the processing proceeds to S32, whereas if all the combinations of high-load segments have been extracted, the control unit terminates the dependency relationship detection processing.

Next, a description will be given of the high-load segment log table with reference to FIG. 10. FIG. 10 is a diagram illustrating an example of the high-load segment log table according to the second embodiment. A high-load segment log table 220 records a high-load segment in the latest 30 minutes as a log. The recording time 30 minutes of the log is an example, and the recording time may be changed to any number in accordance with a use environment. The recording time of the log may be rephrased to a monitoring time period for detecting a dependency relationship.

The high-load segment log table 220 includes an item “time”, an item “segment ID”, and an item “number of accesses”. The item “time” represents time that goes back in time by “−t” with the latest time as “0”. The item “segment ID” records identification information that allows a segment to be uniquely identified. The item “number of accesses” records the number of accesses to the segment identified by the segment ID.

For example, the high-load segment log table 220 indicates that there are three high-load segments, namely segments of segment IDs “S#322”, “S#25”, and “S#8” at time “0”, and that the segments have the number of accesses of “2,054”, “1,980”, and “1,672”, respectively.

It is assumed that high-load segments recorded at a same time belong to a same time window. For example, a high-load segment recorded at time “0” belongs to the latest time window, and a high-load segment recorded at time “−1” belongs to the time window of one minute before.

Next, a description will be given of the frequency table with reference to FIG. 11. FIG. 11 is a diagram illustrating an example of the frequency table according to the second embodiment.

A frequency table 230 is a table in which the frequency (the number of accesses) of the high-load segment having the segment ID “S#322” after accessing the high-load segment having the segment ID “S#38” is recorded for each time difference.

The frequency table 230 includes an item “time difference” and an item “frequency”. The item “time difference” represents an access interval of two high-load segments, that is to say, a time difference. The item “frequency” records the number of times that the segment having the segment ID “S#322” became high load after the segment having the segment ID “S#38” had become high load for each time difference.

For example, the frequency table 230 indicates that one minute after the segment having the segment ID “S#38” had become high load, the number of times that the segment having the segment ID “S#322” became high load is “28”. Two minutes after the segment having the segment ID “S#38” had become high load, the number of times that the segment having the segment ID “S#322” became high load is “36”. Three minutes after the segment having the segment ID “S#38” had become high load, the number of times that the segment having the segment ID “S#322” became high load is “22”.

Here, the description of frequency “35+1” indicates that the frequency is incremented by one from the number of accesses in response to the detection of accesses in the high-load segment log table 220. The high-load segment log table 220 indicates that the segment ID “S#322” is recorded at time “0”, and the segment ID “S#38” is recorded two minutes before that time (time “−2”).

In this manner, the frequency table of the combination is updated for each combination of a high-load segment belonging to the latest time window and another high-load segment in the high-load segment log table 220.

Next, a description will be given of the dependency relationship table with reference to FIG. 12. FIG. 12 is a diagram illustrating an example of the dependency relationship table according to the second embodiment.

A dependency relationship table 240 records the detected dependency relationships. A dependency relationship is detected by referencing the frequency table for each combination of high-load segments, and detecting a combination of high-load segments having a ratio of the frequency exceeding a threshold value (for example, 50%) among the overall frequencies recorded for each time difference.

The dependency relationship table 240 includes an item “dependency relationship”, an item “time difference”, and an item “establishment probability”. The item “dependency relationship” is a combination of high-load segments for which a dependency relationship has been detected. The item “time difference” is an access interval of the two high-load segments for which the dependency relationship has been detected. The item “establishment probability” is a ratio of the frequency, which is identified based on the item “dependency relationship” and the item “time difference”, to the overall frequencies.

For example, the dependency relationship “S#0→S#322” and the time difference “three minutes” indicate that after three minutes from the access to the high-load segment having the segment ID “S#0”, access is made to the high-load segment having the segment ID “S#322”. The dependency relationship table 240 indicates that the frequency identified based on the dependency relationship “S#0→S#322” and the time difference “three minutes” occupies “52%” of all the frequencies. The dependency relationship “S#8→S#15” and the time difference “two minutes” indicate that after two minutes from the access to the high-load segment having the segment ID “S#8”, access is made to the high-load segment having the segment ID “S#15”. The dependency relationship table 24 indicates that the frequency identified based on the dependency relationship “S#8→S#15” and the time difference “two minutes” occupies “66%” of all the frequencies. The dependency relationship “S#16→S#7” and the time difference “five minutes” indicate that after five minutes from the access to the high-load segment having the segment ID “S#16”, access is made to the high-load segment having the segment ID “S#7”. The dependency relationship table 24 indicates that the frequency identified based on the dependency relationship “S#16→S#7” and the time difference “five minutes” occupies “72%” of all the frequencies.

Next, a description will be given of the frequency table update processing according to the second embodiment with reference to FIG. 13. FIG. 13 is a diagram illustrating a flowchart of the frequency table update processing according to the second embodiment.

The frequency table update processing is the processing for updating the frequency table by reflecting the combination of high-load segments extracted in S32 of the dependency relationship detection processing. The frequency table update processing is the processing performed by the control unit in S33 of the dependency relationship detection processing.

S41: The control unit refers to the high-load segment log table, and extracts one of upper segments from the latest time window. For example, the control unit extracts the high-load segment having the segment ID “S#322” from the high-load segment log table 220 as an upper segment.

S42: The control unit refers to the high-load segment log table, and selects one of the holding time windows. For example, the control unit selects the time window of one minute before from the high-load segment log table 220.

S43: The control unit refers to the high-load segment log table, and selects one of upper segments from the selected time window. For example, when the control unit selects the time window of one minute before in the high-load segment log table 220, the control unit extracts the high-load segment having the segment ID “S#0” as an upper segment.

S44: The control unit calculates a time difference between the two extracted segments (upper segments). For example, a time difference between the high-load segment having the segment ID “S#322” extracted from the latest time window and the high-load segment having the segment ID “S#0” extracted from the selected time window is “1”.

If the same upper segment is in another time window, the control unit determines an upper segment having the smallest time difference to be a target of calculating the time difference, and determines the other upper segments not to be a target of calculating the time difference. For example, the high-load segment having the segment ID “S#0” extracted from the time window of 10 minutes before does not become the target of calculating the time difference, because the high-load segment having the segment ID “S#0” is extracted from the time window of one minute before.

S45: The control unit updates the frequency table on the basis of the combination of high-load segments and the calculated time difference. The control unit increments the corresponding frequency by one so as to update the frequency table.

S46: The control unit determines whether all the upper segments have been extracted from the selected time window or not. If the control unit has extracted all the upper segments from the selected time window, the processing proceeds to S47. If the control unit has not extracted some of the upper segments from the selected time window, the processing proceeds to S43, and the control unit selects another upper segment in S43.

S47: The control unit refers to the high-load segment log table, and determines whether all the holding time windows have been selected or not. If the control unit has selected all the holding time windows, the processing proceeds to S48. If the control unit has not selected some of the holding time windows, the processing proceeds to S42, and the control unit selects another time window in S42.

S48: The control unit determines whether all the upper segments have been extracted from the latest time window or not. If the control unit has not extracted some of the upper segments from the latest time window, the processing proceeds to S41, and extracts another upper segment in S41. If the control unit has extracted all the upper segments from the latest time window, the frequency table update processing is terminated.

In this manner, the control unit may individually record access frequencies of the combinations of the current high-load segment and the past high-load segment for each time difference in the frequency table.

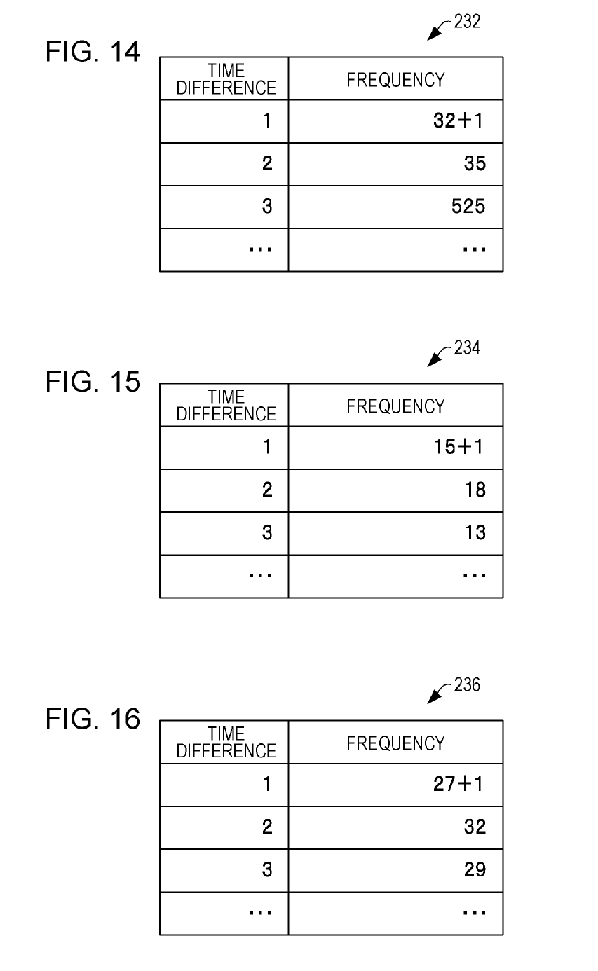

A description will be given of an update example of such a frequency table with reference to FIG. 14 to FIG. 16. FIG. 14 is a diagram illustrating a frequency table of a combination (from segment ID “S#0” to “S#322”) of the current high-load segment and the past high-load segment according to the second embodiment.

A frequency table 232 is a table in which the frequency (the number of accesses) of the high-load segment having the segment ID “S#322” after accessing the high-load segment having the segment ID “S#0” is recorded for each time difference. The frequency table 232 has a similar structure to that of the frequency table 230. The item “frequency” records the number of accesses to the high-load segment having the segment ID “S#322” after accessing the high-load segment having the segment ID “S#0” for each time difference.

For example, the frequency table 232 indicates that after one minute from the access to the high-load segment having the segment ID “S#0”, there has been “33” accesses to the high-load segment having the segment ID “S#322”. Here, the description of the frequency “32+1” indicates that the frequency is incremented by one from the number of accesses in response to the detection of accesses in the high-load segment log table 220. The high-load segment log table 220 indicates that the segment ID “S#322” is recorded at time “0”, and the segment ID “S#0” is recorded one minute before that time (time “−1”

FIG. 15 is a diagram illustrating a frequency table of a combination (from segment ID “S#5” to “S#322”) of the current high-load segment and the past high-load segment according to the second embodiment.

A frequency table 234 is a table in which the frequency (the number of accesses) of the high-load segment having the segment ID “S#322” after accessing the high-load segment having the segment ID “S#5” is recorded for each time difference. The frequency table 234 has a similar structure to that of the frequency table 230. The item “frequency” records the number of accesses to the high-load segment having the segment ID “S#322” after accessing the high-load segment having the segment ID “S#5” for each time difference.

For example, the frequency table 234 indicates that after one minute from the access to the high-load segment having the segment ID “S#5”, there has been “16” accesses to the high-load segment having the segment ID “S#322”. Here, the description of the frequency “15+1” indicates that the frequency is incremented by one from the number of the accesses in response to the detection of accesses in the high-load segment log table 220. The high-load segment log table 220 indicates that the segment ID “S#322” is recorded at time “0”, and the segment ID “S#5” is recorded one minute before that time (time “−1”).

FIG. 16 is a diagram illustrating a frequency table of a combination (from segment ID “S#225” to “S#322”) of the current high-load segment and the past high-load segment according to the second embodiment.

The frequency table 236 is a table in which the frequency (the number of accesses) of the high-load segment having the segment ID “S#322” after accessing the high-load segment having the segment ID “S#225” is recorded for each time difference. The frequency table 236 has a similar structure to that of the frequency table 230. The item “frequency” records the number of accesses to the high-load segment having the segment ID “S#322” after accessing the high-load segment having the segment ID “S#225” for each time difference.

For example, the frequency table 236 indicates that after one minute from the access to the high-load segment having the segment ID “S#225”, there has been “28” accesses to the high-load segment having the segment ID “S#322”. Here, the description of the frequency “27+1” indicates that the frequency is incremented by one from the number of the accesses in response to the detection of accesses in the high-load segment log table 220. The high-load segment log table 220 indicates that the segment ID “S#322” is recorded at time “0”, and the segment ID “S#225” is recorded one minute before that time (time “−1”).

Next, a description will be given of high-frequency category search processing according to the second embodiment with reference to FIG. 17. FIG. 17 is a diagram illustrating a flowchart of the high-frequency category search processing according to the second embodiment.

The high-frequency category search processing is processing for searching, with reference to a frequency table, a combination of high-load segments having a heavy access frequency for each time difference. The high-frequency category search processing is the processing performed by the control unit in S34 in the dependency relationship detection processing.

S51: The control unit selects one of the frequency tables updated in the frequency table update processing performed immediately before in the dependency relationship detection processing.

S52: The control unit calculates a total frequency of all the categories (time differences) in the frequency table selected in S51.

S53: The control unit performs grouping of three categories in ascending order of time difference in order to generate a group. Here, grouping of three categories is one example, and grouping may be performed for one category, two adjacent categories, or four or more continuous categories.

S54: The control unit calculates a total frequency of the group generated in S53.

S55: The control unit determines whether the ratio of the total frequency of the group to the total frequency of all the categories is 50% or more. If the ratio of the total frequency of the group to the total frequency of all the categories is 50% or more, the processing proceeds to S56, whereas if the ratio is less than 50%, the processing proceeds to S57. The threshold value of 50% is an example, and the threshold value to be used for the determination may be set to any number in accordance with a use environment (for example, a communication band, the storage capacity of the SSD 30, or the like).

S56: The control unit detects a high frequency category for the dependency relationship identified in the selected frequency table. The control unit makes the high frequency category identifiable, and holds it temporarily.

S57: The control unit shifts the grouping performed in S53 by one time difference in the direction of a larger time difference.

S58: The control unit determines whether the total frequencies of all the groups have been calculated. If the total frequencies of all the groups have been calculated, the processing proceeds to S59, whereas if the total frequencies of some groups have not been calculated, the processing proceeds to S54.

S59: The control unit determines whether all the updated frequency tables have been selected or not. If some of the updated frequency tables have not been selected, the processing proceeds to S51 and another frequency table is selected. If all the updated frequency tables have been selected, the control unit terminates the high-frequency category search processing.

In this manner, the control unit may detect a combination of high-load segments having a strong dependency relationship and the time difference thereof. The criterion of the strength of dependency relationship may be adjusted by the threshold value set in S55.

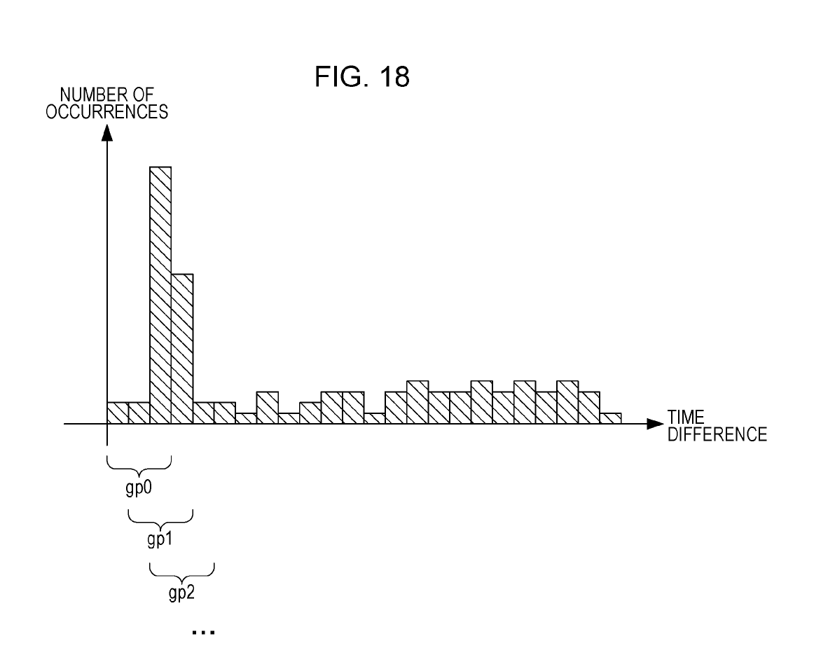

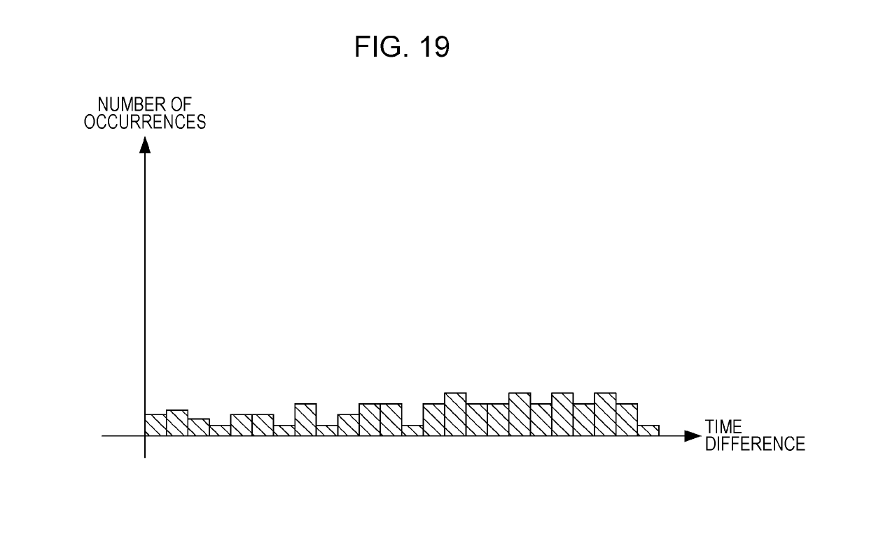

Next, a description will be given of a frequency table that allows detection of a high frequency category with reference to FIG. 18 and FIG. 19. FIG. 18 is a diagram illustrating an example of a histogram based on a frequency table, which allows detection of a high frequency category, according to the second embodiment.

A frequency table that allows detecting a high frequency category has a large number of occurrences in a specific time difference band. The control unit determines (evaluates) whether the ratio of a group gp0, which is generated by grouping the categories of time difference “1”, time difference “2”, and time difference “3” in the frequency table, to the entirety is over a threshold value or not. In this case, the evaluation of the group gp0 is that the ratio of occupying the entirety is not over the threshold value, and thus it becomes not possible to detect a high frequency category. When the group gp0 is shifted, group gp1 is generated by grouping the categories of time difference “2”, time difference “3”, and time difference “4”. The group gp1 has a large number of occurrences in the time difference “3”, and the time difference “4”. Accordingly, the evaluation of the group gp1 is that the ratio of occupying the entirety is over the threshold value, and thus a high frequency category is detected. Subsequently, the evaluation after group gp2, which is generated by shifting the group gp1, is omitted. Such a histogram has a peak in a specific time difference band. That is to say, in such a combination of high-load segments, a dependency relationship is recognized in a specific time difference band.

On the other hand, a frequency table that makes it difficult to detect a high frequency category conduces to a histogram as illustrated in FIG. 19. FIG. 19 is a diagram illustrating an example of a histogram based on a frequency table, which makes it difficult to detect a high frequency category, according to the second embodiment. Such a histogram is flat on the whole, and does not have a peak in a specific time difference band. That is to say, in such a combination of high-load segments, a dependency relationship is not recognized in a specific time difference band.

Next, a description will be given of dependency relationship table update processing according to the second embodiment with reference to FIG. 20. FIG. 20 is a diagram illustrating a flowchart of the dependency relationship table update processing according to the second embodiment.

The dependency relationship table update processing is processing for updating the dependency relationship table by reflecting the dependency relationship detected in S34 of the dependency relationship detection processing. The dependency relationship table update processing is the processing performed by the control unit in S35 of the dependency relationship detection processing.

S61: The control unit determines whether there is a high-frequency category with regard to a target combination of high-load segments or not. If there is a high-frequency category, the processing proceeds to S64, whereas if there is no high-frequency category, the processing proceeds to S62. The control unit may determine whether there is a high-frequency category or not by detecting a high frequency category in S56 of the high-frequency category search processing.

S62: The control unit determines whether the combination of high-load segments, for which no high-frequency category is detected in the dependency relationship detection processing, is recorded in the dependency relationship table or not. If the combination of high-load segments for which no high-frequency category is detected is recorded in the dependency relationship table, the processing proceeds to S63, whereas if the combination is not recorded in the dependency relationship table, the processing proceeds to S68.

S63: The control unit deletes the combination of high-load segments, for which no high-frequency category is detected, from the dependency relationship table, and the processing proceeds to S68.

S64: The control unit determines whether the combination of high-load segments, for which a high-frequency category is detected in the dependency relationship detection processing, is recorded in the dependency relationship table or not. If the combination of high-load segments for which a high-frequency category is detected is recorded in the dependency relationship table, the processing proceeds to S66, whereas if the combination is not recorded in the dependency relationship table, the processing proceeds to S65.

S65: The control unit adds the combination of high-load segments, for which a high-frequency category is detected, to the dependency relationship table.

S66: The control unit compares the time difference of the combination of high-load segments for which a high-frequency category is detected and the time difference of the same combination of high-load segments that is already recorded in the dependency relationship table, and determines whether they are the same or not. If the two time differences are the same, the processing proceeds to S68, whereas if the two time differences are not the same, the processing proceeds to S67.

S67: The control unit updates the dependency relationship table by the time difference of the combination of high-load segments for which a high-frequency category is detected.

S68: The control unit determines whether the dependency relationships have been updated (including add, and delete) for all the combinations of high-load segments or not. If the dependency relationships have not been updated for some of the combinations of high-load segments, the processing proceeds to S61, whereas if the dependency relationships have been updated for all the combinations of high-load segments, the dependency relationship table update processing is terminated.

Next, a description will be given of read-ahead data determination processing according to the second embodiment with reference to FIG. 21. FIG. 21 is a diagram illustrating a flowchart of the read-ahead data determination processing according to the second embodiment.

The read-ahead data determination processing is processing for determining data to be the target of read ahead. The read-ahead data determination processing is the processing performed by the control unit in S25 of the read-ahead control processing.

S71: The control unit determines whether there are any entries including the current high-load areas (high-load segments) as starting points of dependency relationships in the dependency relationship table. If there are some entries including the current high-load areas as starting points of dependency relationships in the dependency relationship table, the processing proceeds to S72, whereas if there is no entry, the read-ahead data determination processing is terminated.

S72: The control unit adds segments included as ending points in the entries, which include the current high-load areas as starting points, to a transfer scheduled segment table. The transfer scheduled segment table is a table in which high-load segments to be copied from the HDD 31 to the SSD 30 are recorded. A description will be given later of the details of the transfer scheduled segment table with reference to FIG. 22. After the control unit added the segments included in the entries as ending points to the transfer scheduled segment table, the read-ahead data determination processing is terminated.

Next, a description will be given of the transfer scheduled segment table with reference to FIG. 22. FIG. 22 is a diagram illustrating an example of the transfer scheduled segment table according to the second embodiment.

A transfer scheduled segment table 250 records transfer scheduled segments, that is to say, the high-load segments to be copied from the HDD 31 to the SSD 30.

The transfer scheduled segment table 250 includes an item “segment ID”, and an item “time”. The item “segment ID” records identification information that allows a segment to be uniquely identified. The item “time” indicates a time until transfer completion.

For example, the high-load segment having the segment ID “S#15” is to be copied from the HDD 31 to the SSD 30 and the time until transfer completion of the segment is “two minutes”. The high-load segment having the segment ID “S#12” is to be copied from the HDD 31 to the SSD 30 and the time until transfer completion of the segment is “four minutes”.

Next, a description will be given of data transfer processing according to the second embodiment with reference to FIG. 23. FIG. 23 is a flowchart illustrating the data transfer processing according to the second embodiment.

The data transfer processing is the processing in which data stored in the segment determined in S25 of the read-ahead control processing is copied (transferred) to the SSD 30. The data transfer processing is the processing performed by the control unit in S26 of the read-ahead control processing.

S81: The control unit calculates priorities of transfer scheduled segments (high-load segments) in the transfer scheduled segment table. The expression (1) may be used for calculating the priorities.

Priority=(establishment probability×the average number of accesses)/time until transfer completion (1)

The establishment probability in the expression (1) may be obtained from the item “establishment probability” in the dependency relationship table. The average number of accesses in the expression (1) may be obtained by calculating an average value of the item “frequency” in the frequency table. The time until transfer completion may be obtained from the item “time” in the transfer scheduled segment table. According to the expression (1), when there are two or more transfer scheduled segments having the same establishment probability×the average number of accesses, the control unit gives higher priority to a transfer scheduled segment having a smaller time until transfer completion.

S82: The control unit determines a transfer scheduled segment having the highest priority out of the transfer scheduled segments in the transfer scheduled segment table.

S83: The control unit copies data of the transfer scheduled segment having the highest priority from the HDD 31 to the SSD 30. The control unit transfers data on segment basis. This data transfer is completed before the next data transfer processing is performed, and thus another data transfer will not be performed in an incomplete state of the current data transfer. To put it another way, the interval (for example, one minute) of data transfer processing is longer than a time taken for transferring data of one high-load segment. The control unit performs data transfer one by one for each segment in accordance with the priority, and inhibits parallel data transfer of two or more segments to avoid abortion of data transfer within respective times.

In this manner, the storage apparatus 13 detects the dependency relationship of accesses having a time difference so as to improve read ahead precision, and improves the access performance of the SSD 30 and the HDD 31. It has not been possible to make such improvements by the read ahead responding to sequential access, or the read ahead responding to random access. The read ahead by detecting a dependency relationship of accesses having a time difference allows taking a larger time until transfer completion of data compared with read ahead techniques known so far, and thus excessive wide communication band is not used. The storage apparatus 13 may perform the read ahead by detecting a dependency relationship of accesses having a time difference together with the read ahead techniques known so far.

In the high-frequency category search processing, the storage apparatus 13 searches for a category having a high access frequency by comparing the ratio of the total frequency of a group to the total frequency of all the categories with a threshold value. However, a well-known statistical determination method may be used. For example, the storage apparatus 13 may detect a significant difference from the Poisson distribution using a method of testing.

The above-described processing functions may be achieved by a computer. In that case, a program describing the processing contents of the functions of the storage control apparatus 2 or the storage apparatus 13 is provided. By executing the program on a computer, the above-described processing functions are achieved by the computer. The programs describing the processing contents may be recorded on a computer-readable recording medium. Examples of the computer-readable recording medium include a magnetic storage device, an optical disc, a magneto-optical recording medium, a semiconductor memory, and the like. Examples of the magnetic storage device include an HDD, a flexible disk (FD), a magnetic tape, and the like. Examples of the optical disc include a DVD, a DVD-RAM, a CD-ROM/RW, and the like. Examples of the magneto-optical recording medium include a magneto-optical disk (MO) and the like.

In order to distribute the program, for example, a portable recording medium, such as a DVD, a CD-ROM, and the like on which the program is recorded is marketed. Also, the program may be stored in a storage device of a server computer, and transferred from the server computer to another computer through a network.

The computer that executes the program stores the program recorded on the portable recording medium, or the program transferred from the server computer into the own storage device, for example. Then, the computer reads the program from the own storage device, and performs processing in accordance with the program. The computer may directly read the program from the portable recording medium, and to execute the processing in accordance with the program. Also, the computer may sequentially execute processing in accordance with a program received from a server computer connected through a network each time the program is transferred from the server computer.

Also, at least a part of the above-described processing functions may be achieved by an electronic circuit, such as a DSP, an ASIC, a PLD, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus, comprising:
a processor configured to
detect a dependency relationship between a first data access and a second data access made after passage of a delay time from the first data access, the first data access being made to a first storage area in a first storage device, the second data access being made to a second storage area in the first storage device, and
transfer, when a current data access is made to the first storage area in a state in which the dependency relationship is detected, data in the second storage area to a second storage device before the delay time passes, the second storage device having a higher access speed than the first storage device.

2. The storage control apparatus according to claim 1, wherein
the processor is configured to
detect a first time slot in which the first data access is made, the first time slot being one of contiguous time slots, each of the contiguous time slots having a first time span,
detect a second time slot in which the second data access is made, the second time slot being another one of the contiguous time slots,
count the delay time by the time slots each time the second data access is made, and
detect the dependency relationship on basis of a deviation of the delay time.

3. The storage control apparatus according to claim 2, wherein
the first time span is larger than a time taken for transferring data in the second storage area.

4. The storage control apparatus according to claim 1, wherein
the processor is configured to
transfer, if there are a plurality of candidates of data to be transferred, the plurality of candidates one by one in accordance with priorities set for the plurality of candidates.

5. The storage control apparatus according to claim 4, wherein
the processor is configured to
set a higher priority for a first candidate among the plurality of candidates, the first candidate having a shorter remaining time until completion of data transfer.

6. The storage control apparatus according to claim 1, wherein
each of the first storage area and the second storage area is a management unit produced by dividing a storage area in the first storage device into parts having a predetermined unit size.

7. The storage control apparatus according to claim 6, wherein
the management unit is a unit of transferring data.

8. A storage system, comprising:
a first storage device;
a second storage device having a higher access speed than the first storage device; and
a storage control apparatus including:
a processor configured to
detect a dependency relationship between a first data access and a second data access made after passage of a delay time from the first data access, the first data access being made to a first storage area in the first storage device, the second data access being made to a second storage area in the first storage device, and
transfer, when a current data access is made to the first storage area in a state in which the dependency relationship is detected, data in the second storage area to the second storage device before the delay time passes.

9. A computer-readable recording medium having stored therein a program for causing a computer to execute a process, the process comprising:
detecting a dependency relationship between a first data access and a second data access made after passage of a delay time from the first data access, the first data access being made to a first storage area in a first storage device, the second data access being made to a second storage area in the first storage device; and
transferring, when a current data access is made to the first storage area in a state in which the dependency relationship is detected, data in the second storage area to a second storage device before the delay time passes, the second storage device having a higher access speed than the first storage device.
